(19) United States
(12) Patent Application Publication
(10) Pub. No.: US 2008/0148954 A1
(43) Pub. Date: Jun. 26, 2008

(54) SAFETY BREWER

(76) Inventor: Algert J. Maldanis, Heath, TX (US)

Correspondence Address: Law Office of J. D. Pemberton;John D. Pemberton, 7405 Buckskin Court, Fort Worth, TX, 76137, US

(21) Appl. No.: 11/736,783

(22) Filed: Apr. 18, 2007

Related U.S. Application Data
(60) Provisional application No. 60/871,667, filed on Dec. 22, 2006.

(51) Int. Cl. A47J 31/44

(52) U.S. Cl. 99/279

(57) ABSTRACT

A system that allows for safety checks to determine if the brew chamber is inserted correctly, if the carafe is positioned correctly, and if the water pressure in the water lines is at an acceptable safe level. During use, a brewer is activated via a control panel. Before activation and during the brewing cycle, the system checks to determine if the brew chamber is inserted correctly, if the carafe is properly positioned, and if water pressure in the water lines of the brewer are at an acceptable level. If any one of those conditions are not met, then the brewer will not operate and will thus prevent water from being sprayed, splashed, or spilled onto a nearby operator, individual, or surrounding area and causing potentially serious burns or significant water damage to the surrounding area.

### CLAIM OF PRIORITY

This application claims the benefit of U.S. Provisional Application No. 60/871,667 filed Dec. 22, 2006 which is incorporated herein by reference.

### BACKGROUND OF THE INVENTION

1. Technical Field

This invention relates to brewers, and more particularly, to commercial brewers for coffee and iced-tea.

2. Description of Related Art

It has been known for centuries to prepare coffee, tea, herb extracts and other flavor-containing liquids by steeping the corresponding flavor containing solid materials in hot water under ambient or elevated pressure. The steeping of roasted and ground coffee under ambient pressure emerged in late 14th century and throughout the 19th and even the early 20th centuries, it was considered adequate to add ground coffee to hot water in a saucepan, boil the mixture until it smelled right, and pour the brew into a cup. It was not until, later in the 20th century, that coffee making became somewhat automated.

The modern coffeemaker is a kitchen appliance used to brew coffee without having to boil water in a separate container. While there are many different types of coffeemakers using a number of different brewing principles, in the most common devices, coffee grounds are placed in a paper or metal filter inside a brewing chamber. The brewing chamber is then set over a glass or ceramic coffee pot typically called a carafe. Cold water is poured into a separate chamber, heated up to the boiling point, and directed into the brewing chamber. This is commonly called an automatic drip-brew or drip brew coffee maker and is the most popular method used to brew coffee or tea.

One of the problems with drip brew coffee makers is that the temperature of water used to brew the flavor containing solid materials is typically between about 197 degrees to about 205 degrees Fahrenheit. If the basket is not installed properly, then hot water and/or the flavor containing solid materials may be sprayed, splashed, or spilled onto a nearby operator or individual resulting in potentially serious burns. Also, if the carafe is not properly placed on the platform directly under the brewing chamber to collect the flavor containing liquid, then the hot liquid could also be sprayed, splashed, or spilled onto a nearby operator or individual resulting in potentially serious burns. In addition, tank type brewers have been know to have a leak in a water hose or someplace else in the water system and such a leak could cause significant water damage if the leak occurred during an time or at location where the brewer is not regularly monitored.

What is needed is a brewer that contains safety devices to prevent the most common mistakes made when using a drip coffee maker such as the basket not being installed properly, the carafe not positioned properly, or a leak in the water lines of the brewer.

### SUMMARY OF INVENTION

The present invention solves the above-described problem by providing a system that allows for safety checks to determine if the brew chamber is inserted correctly, if the carafe is positioned correctly, and if the water pressure in the water lines is at an acceptable safe level.

To ensure the brew chamber is inserted correctly, at least one safety sensor checks to see that the brew chamber is properly installed on a chamber support rail. In one embodiment, two safety sensors ensure that the brew chamber is properly installed on two chamber support rails. The at least one safety sensor is electronically or mechanically monitored and if the brew chamber is not inserted properly, then the brewer will not function. In one embodiment, the brewer flashes an alert or warning to inform the user that the brew chamber is not inserted properly.

To ensure the carafe is properly positioned, a carafe safety sensor monitors whether or not a carafe is placed directly under the brewing chamber, typically on a platform. The platform may have guides to ensure that if a carafe is placed on the platform, it will be located in the correct position. In another embodiment, the safety sensor monitors whether or not the carafe is on the platform and whether or not the carafe is located in the proper position. If the carafe is not properly positioned, then the brewer will not function. In one embodiment, the brewer flashes an alert or warning to inform the user that the carafe is not properly positioned.

To ensure the water pressure in the water lines of the brewer is at an acceptable level, at least one pressure sensor is used to monitor the pressure in the water lines. Should the pressure be insufficient for brewing or a serious leak develop within the brewer, the pressure sensor will cause an inlet water solenoid to close and thus prevent the brewer from overheating due to lack of water or will prevent water from being sprayed, splashed, or spilled onto a nearby operator, individual, or surrounding area and potentially causing serious burns or significant water damage to the surrounding area.

During use, the brewer is activated via a control panel. Before activation, the system checks to determine if the brew chamber is inserted correctly, if the carafe is properly positioned, and if the water pressure in the water lines of the brewer are at an acceptable level. If any one of those conditions are not met, then the brewer will not operate and in one embodiment, will provide a warning or alert to the operator notifying the operator of the specific problem.

Other features and advantages of the present invention will become apparent upon reading the following detailed description of embodiments of the invention, when taken in conjunction with the appended claims.

### BRIEF DESCRIPTION OF THE DRAWINGS

FIG. 1 is a front view of the brewer in accordance with an embodiment of the present invention.

FIG. 2 is a side view of the brew chamber safety device in accordance with an embodiment of the present invention.

FIG. 3 is a block diagram of the carafe safety device in accordance with an embodiment of the present invention.

FIG. 4 is a block diagram of the water pressure sensor safety device in accordance with an embodiment of the present invention.

FIG. 5 is a flow diagram depicting the steps used in accordance with an embodiment of the present invention.

### DETAILED DESCRIPTION OF THE INVENTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

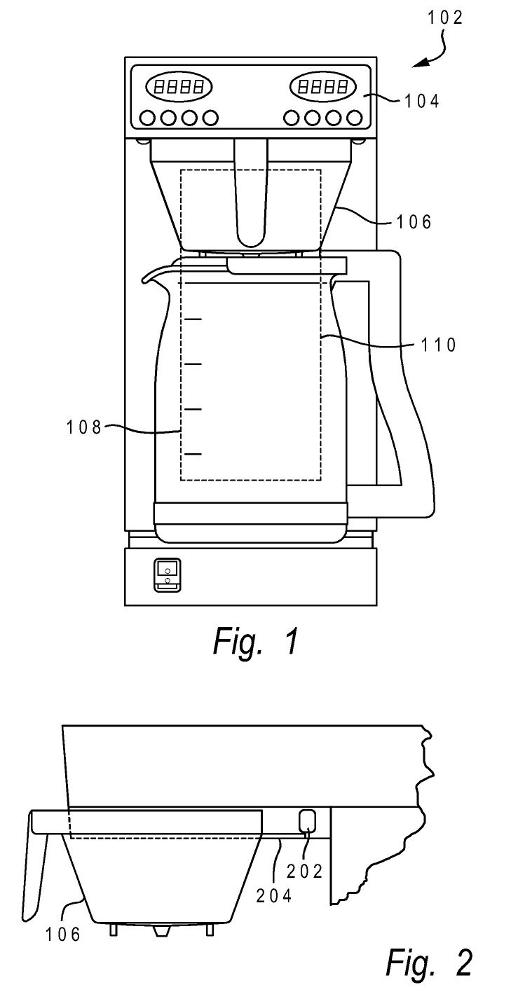

Referring to FIG. 1, shown is brewer 102 containing control panel 104, brew chamber 106, carafe 108, and water supply system 110. Control panel 104 allows the user to control the operation of brewer 102. Brew chamber 106 contains the flavor containing solid material that is to be brewed and such material may be any flavor containing solid material that may be brewed such as coffee or tea. Carafe 108 captures and stores the brewed flavor containing liquid. Water supply system 110 supplies the water for use by brewer 102.

FIG. 2 is a side view showing brew chamber 106 and at least one safety sensor 202. Safety sensor 202 insures brew chamber 106 is properly inserted. At least one safety sensor 202 is installed on support rail 204 and in one embodiment, two safety sensors 202 sensors ensure that brew chamber 106 is properly installed on two support rails 204. Support rail 204 supports and secures brew chamber 106 during the brewing process.

When brew chamber 106 is properly inserted into support rail 204, safety sensor 202 sends a signal to control panel 104 informing control panel 104 that brew chamber 106 is properly inserted. Safety sensor 202 may be an optical sensor, magnetic sensor, mechanical sensor, or any other sensor known in the art able to send an electrical or mechanical signal when brew chamber 106 is properly inserted.

The signal sent by safety sensor 202 to control panel 104 is used to determine if the brewing process can begin and if not, control panel 104 may display an alert or warning signal alerting a user that brew chamber 106 is not properly inserted into support rail 204. In addition, control panel 104 may display a signal when brew chamber 106 is properly inserted into support rail 204.

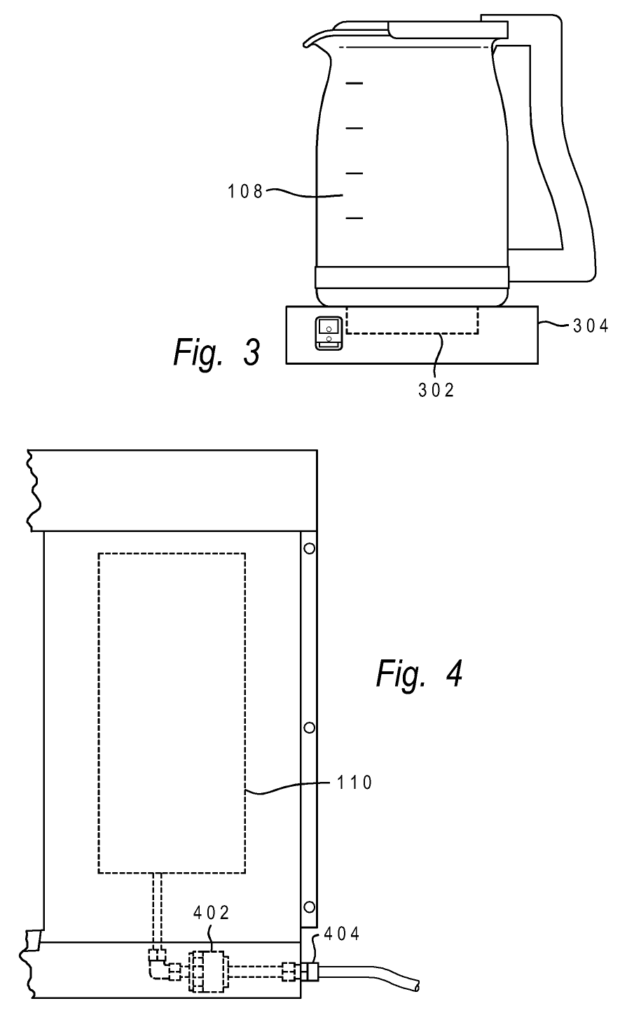

As shown in FIG. 3, to ensure carafe 108 is properly positioned on platform 304, brewer 102 contains carafe safety sensor 302. Carafe safety sensor 302 monitors whether or not carafe 108 is properly placed to collect the brewed liquid from brew chamber 104. Typically, carafe 108 is properly positioned when it is placed on platform 304 directly under brew chamber 104.

When carafe 108 is properly positioned on platform 304, carafe safety sensor 302 sends a signal to control panel 104 informing control panel 104 that carafe 108 is properly positioned on platform 304. Carafe safety sensor 302 may be an optical sensor, magnetic sensor, mechanical sensor, or any other sensor known in the art able to send an electrical or mechanical signal when carafe 108 is properly positioned on platform 304. In one embodiment, carafe safety sensor 302 sends a signal that carafe 108 is properly positioned when at least about 1.5 pounds is placed on platform 304. Platform 304 may contain a heating element that helps keep the liquid in carafe 108 warm.

The signal sent by carafe safety sensor 302 to control panel 104 is used to determine if the brewing process can begin and if not, control panel 104 may display an alert or warning signal alerting a user that carafe 108 is not properly positioned on platform 304. In addition, control panel 104 may display a signal when carafe 108 is properly positioned on platform 304.

As shown in FIG. 4, brewer 102 contains at least one pressure sensor 402. At least one pressure sensor 402 monitors the water pressure of the water used by brewer 102. Typically, the pressure of the water used by brewer 102 is at least about 30 pounds per square inch (PSI).

When the water pressure of the water used by brewer 102 is above a predetermined level, at least one pressure sensor 402 sends a signal to control panel 104 informing control panel 104 that the pressure of the water used by brewer 102 is at least above the predetermined level. At least one pressure sensor 402 may be any pressure sensor known in the art able to send an electrical or mechanical signal to control panel 102 when the water pressure of the water used by brewer 102 is at least above the predetermined level or, alternatively, when the pressure of the water used by brewer 102 falls below a predetermined level.

The signal sent by at least one pressure sensor 402 to control panel 104 is used to determine if the brewing process can begin and if not, control panel 104 may display an alert or warning signal alerting a user that the pressure of the water used by brewer 102 is below the predetermined level. In addition, control panel 104 may display a signal when the pressure of the water used by brewer 102 is at or above the predetermined level.

In one embodiment, at least one pressure sensor 402 is located at water inlet 404. Water inlet 404 is where water enters brewer 102 and is the main water source for brewer 102. By locating, at least one pressure sensor 402 proximate to water inlet 404, at least one pressure sensor 402 can detect a leak or problem with almost anywhere in the water system of brewer 102. In addition, a second pressure sensor 402 may be located before the water is heated so if there is a leak or problem with the water system or brewer 102, the problem can be detected and the system can be shut down before hot or heated water is sprayed, splashed, or spilled onto a nearby operator, individual, or surrounding area.

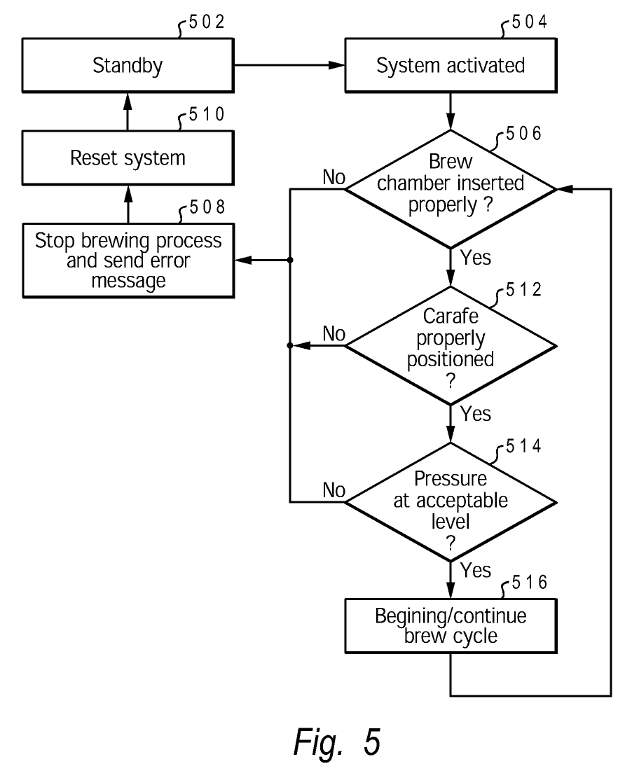

As shown in FIG. 5, before use, the system is in standby mode, Step 502. When a user wants to use the system, the system is first activated by control panel 104, Step 504. Once activated, the system determines if brew chamber 106 is inserted properly, Step 506. If brew chamber 106 is not inserted properly, then the system does not allow the brewing cycle to begin and sends a warning or error message to the user, Step 508.

The warning or error message may be a light, sound, scrolling LED screen, or some other system or method known for alerting users of an operating error. The warning or message error may be a general warning or error message or may be a distinct warning or error message that lets the user know brew chamber 106 is not inserted properly. After the warning or error message is given, the system resets, Step 510 and enters standby mode, Step 502. In another embodiment, the system does not reset but allows the user to correct the problem and once the problem is corrected, the system continues the brewing cycle. In another embodiment, the user is given the choice of whether or not to continue the brewing cycle or to reset the system.

If the system determines that brew chamber 106 is inserted properly, then the system determines if carafe 108 is properly positioned, Step 512. If the system determines carafe 108 is not properly positioned, then the system does not allow the brewing cycle to begin and sends a warning or error message to the user, Step 508.

The warning or error message may be a light, sound, scrolling LED screen, or some other system or method known for alerting users of an operating error. The warning or message error may be a general warning or error message or may be a distinct warning or error message that lets the user know carafe 108 is not properly positioned. After the warning or error message is given, the system resets, Step 510 and enters standby mode, Step 502. In another embodiment, the system does not reset but allows the user to correct the problem and once the problem is corrected, the system continues the brewing cycle. In another embodiment, the user is given the choice of whether or not to continue the brewing cycle or to reset the system.

If the system determines that carafe 108 is properly positioned, then the system determines if the water pressure in the water lines of the brewer is at an acceptable level, Step 514. If the system determines the pressure in the water lines of the brewer is not at an acceptable level, then the system does not allow the brewing cycle to begin and sends a warning or error message to the user, Step 508.

The warning or error message may be a light, sound, scrolling LED screen, or some other system or method known for alerting users of an operating error. The warning or message error may be a general warning or error message or may be a distinct warning or error message that lets the user know the pressure in the water lines of the brewer is not at an acceptable level. After the warning or error message is given, the system resets and enters standby mode, Step 502. In another embodiment, the system does not reset but allows the user to correct the problem and once the problem is corrected, the system continues the brewing cycle. In another embodiment, the user is given the choice of whether or not to continue the brewing cycle or to reset the system.

If the system determines that the pressure in the water lines of the brewer is at an acceptable level, then the system allows the brew cycle to begin, Step 516. Once the brew cycle begins, the system continually monitors the position of brew chamber 106 to ensure it is inserted properly on support rails 204, Step 506, the location of carafe 108 to ensure it is properly positioned, Step 512, and the pressure in the water lines to ensure it is at a proper pressure, Step 516. By monitoring the insertion of the brew chamber 106 on support rails 204, the position of the carafe 108, and the pressure of the water lines used by the system, the system may be able to prevent brewer 102 from overheating due to lack of water or prevent water from being sprayed, splashed, or spilled onto a nearby operator, individual, or surrounding area and causing potentially serious burns or significant water damage to the surrounding area.

It should be understood that the foregoing relates to exemplary embodiments of the invention and that modifications may be made without departing from the spirit and scope of the invention as set forth in the following claims.

What is claimed is:

1. A safety brewing device, the brewing device comprising:
a control panel;
a brew chamber that contains flavor containing solid material to be brewed;
a brew chamber safety sensor to insure the brew chamber is inserted correctly;
a carafe to capture and store brewed flavor containing liquid;
a carafe safety sensor to insure the carafe is properly positioned;
water supply system to supply water for use by brewer; and
a water pressures sensor to ensure the water pressure in the water supply system is at an acceptable level.

2. The brewing device of claim 1 wherein the brewing device contains two rails to secure the brew chamber and the brew chamber safety sensor insures the brew chamber is properly positioned on both rails of the brewing device.

3. The brewing device of claim 1 wherein the brew chamber safety sensor sends a signal to the control panel informing the control panel that the brew chamber is properly inserted.

4. The brewing device of claim 1 wherein the control panel displays a warning if the brew chamber safety sensor is not properly inserted.

5. The brewing device of claim 1 wherein the carafe safety sensor sends a signal to the control panel informing the control panel that the carafe is properly positioned.

6. The brewing device of claim 1 wherein the control panel displays a warning if the carafe is not properly positioned.

7. The brewing device of claim 1 wherein the water pressures sensor sends a signal to the control panel informing the control panel that the water pressure is at an acceptable level.

8. The brewing device of claim 1 wherein the control panel displays a warning if the water pressure is not at an acceptable level.

9. The brewing device of claim 1 wherein the acceptable level of water pressure is at least about 30 PSI.

10. A method of using a safety brewing device wherein the safety brewing device contains a brew chamber, carafe, and requires a minimum amount of water pressure to function properly, the method comprising the steps of:
activating the system via a control panel and beginning a brewing cycle;
determining if a brew chamber is inserted properly;
determining if a carafe is properly positioned;
determining if the water pressure in the water lines of the brewer is at an acceptable level; and
conditioned upon the brew chamber being inserted properly, the carafe being properly positioned, and the water pressure in the water lines of the brewer being at an acceptable level, allowing the brewing cycle to continue.

11. The method of claim 10 wherein conditioned upon the brew chamber not being inserted properly, sending a warning message to a user from the control panel.

12. The method of claim 10 wherein conditioned upon the carafe not being properly positioned, sending a warning message to a user from the control panel.

13. The method of claim 12 wherein the warning message is a visible warning.

14. The method of claim 10 wherein conditioned upon the brew chamber being properly inserted, the carafe being properly positioned, and the water pressure being at an acceptable level, sending a message from the control panel to a user that the brew chamber is properly inserted, the carafe is properly positioned, and the water pressure is at an acceptable level.

15. The method of claim 14 wherein the message is a visible message.

16. The method of claim 10 wherein conditioned upon the water pressure in the water lines of the brewer not being at an acceptable level, sending a warning message to a user from the control panel.

17. The method of claim 16 wherein the warning message is a visible warning.

18. The method of claim 16 wherein the acceptable level of water pressure is at least about 30 PSI.

19. The method of claim 10 wherein conditioned upon the brew chamber not being inserted properly, the carafe not being properly positioned, or the water pressure in the water lines of the brewer not being at an acceptable level, suspending the brewing cycle until the brew chamber is inserted properly, the carafe is properly positioned, or the water pressure in the water lines of the brewer is at an acceptable level.

20. The method of claim 10 comprising the addition step of continually monitoring the insertion of brew chamber, position of the carafe, and pressure in the water lines during the entire brewing cycle.
